(19) United States
(12) Patent Application Publication
(10) Pub. No.: US 2023/0206029 A1
(43) Pub. Date: Jun. 29, 2023

(54) Graph Neural Network Ensemble Learning

(71) Applicant: International Business Machines Corporation, Armonk, NY (US)

(72) Inventors: Mu Qiao, Belmont, CA (US); Wenqi Wei, Atlanta, GA (US); Divyesh Jadav, San Jose, CA (US)

(73) Assignee: International Business Machines Corporation, Armonk, NY (US)

(21) Appl. No.: 17/562,080

(22) Filed: Dec. 27, 2021

(51) Int. Cl. G06N 3/04; G06K 9/62

(52) U.S. Cl. CPC G06N 3/0454; G06K 9/6257

(57) ABSTRACT

A system, computer program product, and method are provided to graph neural network (GNN) ensemble learning. Training data is represented in a graph format, from which two or more subgraphs are sampled. Two or more GNNs are training from feature space sampled from the subgraphs. The GNN ensemble is built from the trained GNNs, and subject to testing data. Application of the testing data to the GNN ensemble generates output in the form of an ensemble value, with the output configured to interface with and selectively control an operatively coupled physical hardware device or software.

### BACKGROUND

The present embodiments relate to a computer system, computer program product, and a computer-implemented method to improve learning performance and adversarial robustness for a graph neural network (GNN). More specifically, embodiments are directed to applying ensemble learning to the GNN.

Graph neural networks (GNNs) are a type of machine learning algorithm that can extract information from graphs and make useful predictions. Every graph is composed of nodes and edges. For example, individual nodes in the graph can represent individuals and their characteristics, while edges can represent relations between individual represented in the nodes. A graph, G, can be defines as G = (V, E), where V is the set of nodes, and E are the edges between two nodes. GNNs are a class of deep learning methods designed to perform training and inference on data described by the graphs.

Graph structured data in the form of the GNN captures relationships, in the form of edges, between entities, in the form of nodes, as well as their associated properties. GNNs contain various patterns, interdependencies, and insights that can be revealed with proper context. Deep leaming on GNNs is challenging due to combinatorial complexity and non-linearity of the graphs. Accordingly, the embodiments shown and described herein are directed to improving learning on GNNs.

### SUMMARY

The embodiments disclosed herein include a computer system, computer program product, and computer-implemented method directed at ensemble learning for graph data. More specifically, the embodiments are directed at improving graph neural network (GNN) learning performance and adversarial robustness through ensemble learning. Those embodiments are further described below in the Detailed Description. This Summary is neither intended to identify key features or essential features or concepts of the claimed subject matter nor to be used in any way that would limit the scope of the claimed subject matter.

In one aspect, a computer system is provided with a processor operatively coupled to memory, and an artificial intelligence (AI) platform operatively coupled to the processor. The AI platform is configured with modules in the form of a data manager, a processing manager, and a director configured with functionality to support training and testing of a graph neural network (GNN) ensemble. The data manager is configured to process a training data set, including representing the training data set in a graph format with nodes and edges. The processing manager, which is operatively coupled to the data manager, leverages the processed training data set to train aspects of the GNN ensemble. More specifically, the processing manager samples subgraphs from the training data set, samples feature space from the sampled subgraph, and leverages the sampled subgraphs to train two or more GNNs so that each of the GNNs are trained from the sampled feature space. The processing manager leverages the trained GNNs and builds a GNN ensemble. The director, which is operatively coupled to the processing manager, is configured to support the testing aspect of the GNN ensemble. More specifically, the director is configured to apply a testing data set to the GNN ensemble from which output data, which is configured to selectively interface with functionality of an operatively coupled device, is generated. The output data from the GNN ensemble is characterized as an ensemble value. In an embodiment, the director leverages a machine learning voting algorithm for selection of the output data as the ensemble value.

In another aspect, a computer program product is provided with a computer readable storage medium having embodied program code. The program code is executable by the processing unit with functionality to support graph neural network (GNN) ensemble learning. Program code is provided to process a training data set, including represent the training data set in a graph format with nodes and edges, which may then be leveraged to train aspects of the GNN ensemble. Program code is provided to sample subgraphs from the training data, sample feature space from the sampled subgraph, and leverage the sampled subgraphs to train two or more GNNs so that each of the GNNs are trained from the sampled feature space. The program code builds the GNN ensemble from the trained GNNs. Program code is further provided to support the testing aspect of the GNN ensemble. More specifically, program code is configured to apply a testing data set to the GNN ensemble from which output data, which is configured to selectively interface with functionality of an operatively coupled device, is generated. The output data from the GNN ensemble is characterized as an ensemble value. In an embodiment, the program code leverages a machine learning voting algorithm for selection of the output data as the ensemble value.

In yet another aspect, a method is provided to support graph neural network (GNN) ensemble learning. A training data set is subject to processing to represent the training data set in a graph format with nodes and edges. The processed training data set is then leveraged to train aspects of the GNN ensemble. More specifically, subgraphs from the training data set are sampled and feature space from the sampled subgraphs is also sampled. The sampled feature space is then leveraged to train two or more GNNs so that each of the GNNs is trained from the sampled feature space. A GNN ensemble is built, or otherwise configured from the trained GNNs. Once trained, the GNN ensemble is subject to testing. More specifically, a testing data set is applied to the GNN ensemble from which output data, which is configured to selectively interface with functionality of an operatively coupled device, is generated. The output data from the GNN ensemble is characterized as an ensemble value. In an embodiment, a machine learning voting algorithm is leveraged for selection of the output data as the ensemble value.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a block diagram illustrating an example graph.

FIG. 2 depicts a block diagram illustrating transformation of graph data into a format that can be processed by a neural network.

FIG. 3 depicts a flow diagram illustrating GNN ensemble training and testing.

FIG. 4 depicts a flow diagram illustrating application of a discriminant function with respect to ensemble learning.

FIG. 5 depicts a flow chart illustrating application of an adversarial attack to the trained GNN ensemble shown and described in FIG. 3.

FIGS. 6A and 6B depict a block diagram illustrating a computer system with tools to support and enable ensemble learning to improve learning performance and adversarial robustness for a GNN.

FIG. 7 depicts a block diagram illustrating artificial intelligence (AI) platform tools and their associated APIs.

FIG. 8 depicts a block diagram illustrating an example of a computer system/server of a cloud based support system, to implement the system and processes described above with respect to FIGS. 1-7.

FIG. 9 depicts a block diagram illustrating a cloud computer environment.

FIG. 10 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language (NL) systems (such as the IBM Watson® artificially intelligent computer system or other natural language interrogatory answering systems) process NL based on system acquired knowledge.

In the field of AI computer systems, natural language processing (NLP) systems process natural language based on acquired knowledge. NLP is a field of AI that functions as a translation platform between computer and human languages. More specifically, NLP enables computers to analyze and understand human language. Natural Language Understanding (NLU) is a category of NLP that is directed at parsing and translating input according to natural language principles. Examples of such NLP systems are the IBM Watson® artificial intelligent computer system and other natural language question answering systems.

Machine learning (ML), which is a subset of AI, utilizes algorithms to learn from data and create foresights based on the data. ML is the application of AI through creation of models, for example, artificial neural networks that can demonstrate learning behavior by performing tasks that are not explicitly programmed. There are different types of ML, including learning problems such as supervised, unsupervised, and reinforcement learning, hybrid learning problems, such as semi-supervised, self-supervised, and multi-instance learning, statistical inference, such as inductive, deductive, and transductive learning, and learning techniques, such as multi-task, active, online, transfer, and ensemble learning.

At the core of AI and associated reasoning lies the concept of similarity. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding NL and processing content response to the identification and understanding as well as changes to the structures are extremely difficult at a practical level.

Artificial neural networks (ANNs) are models of the way the nervous system operates. Basic units are referred to as neurons, which are typically organized into layers. The ANN works by simulating a large number of interconnected processing units that resemble abstract versions of neurons. There are typically three parts in an ANN, including an input layer, with units representing input fields, one or more hidden layers, and an output layer, with a unit or units representing target field(s). The units are connected with varying connection strengths or weights. Input data is presented to the first layer, and values are propagated from each neuron to neurons in the next layer. At a basic level, each layer of the neural network includes one or more operators or functions operatively coupled to output and input. The outputs of evaluating the activation functions of each neuron with provided inputs are referred to herein as activations. Complex neural networks are designed to emulate how the human brain works, so computers can be trained to support poorly defined abstractions and problems where training data is available. ANNs are often used in image recognition, speech, and computer vision applications.

Ensemble learning is directed at the use of algorithms and tools in machine learning to form a collaborative whole where multiple methods are more effective than a single learning method. More specifically, ensemble learning combines predictions from multiple neural network models, instead of a single model, and output from these models are combined. It is understood in the art that combining predictions from multiple neural networks adds a bias that counters variance of a single trained neural network models. Ensemble learning involves training more than one network on the same dataset, and then using each of the trained models to make a prediction before combining the predictions to make a final outcome or prediction.

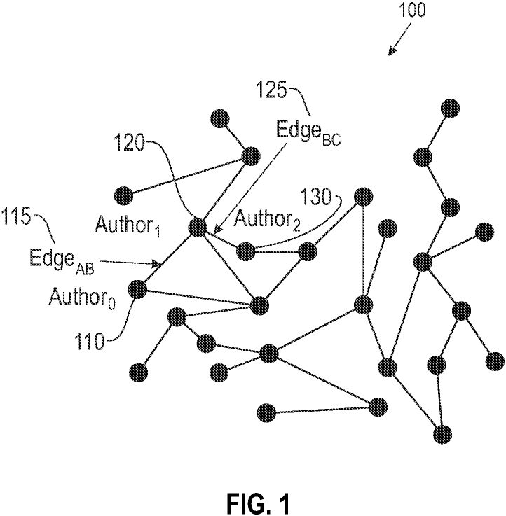

Two types of graphical information are leveraged to build a GNN ensemble, including structure level information and feature level information. The structure level information is directed at a sub-graph of an original graph, and the feature level information is directed at features of nodes in the graph. Referring to FIG. 1, a block diagram (100) is provided to illustrate an example graph. As shown, the graph is comprised of nodes and edges connecting a subset of nodes. Each graph node represents an object and edge that extends between two nodes represents a relationship between the represented objects. By way of example, node_{A} (110) and node_{B} (120) are connected via edge_{AB} (115), and node_{C} (130) is directly connected to node_{B} (120) via edge_{BC} (125) and indirectly connected to node_{A} (110) via edge_{BC} (125) and edge_{AB} (115). The graph shown herein may represent a class or multi-classes of objects. By way of example and as shown herein, the graph represents authors of papers in a specific category of research, with individual nodes representing an author and individual edges representing collaboration relations between authors. For example, a direct edge between two nodes, such as edge_{AB} (115), represents a collaboration on writing a paper by the authors represented at node_{A} (110), e.g. author₀, node_{B} (120), e.g. author₁, and an indirect edge between two nodes, such as two nodes connected via two or more edges and shown herein by way of example node_{A} (110) and node_{C} (130), e.g. author₀ and author₂, indirectly connected via edge_{AB} (115) and edge_{BC} (125), represents a cross collaboration but not a direct collaboration by the authors represented at node_{A} (110) and node_{C} (130). Accordingly, the edges in the example graph represent relationships, including direct and indirect relationships, between objects represented in the graph nodes.

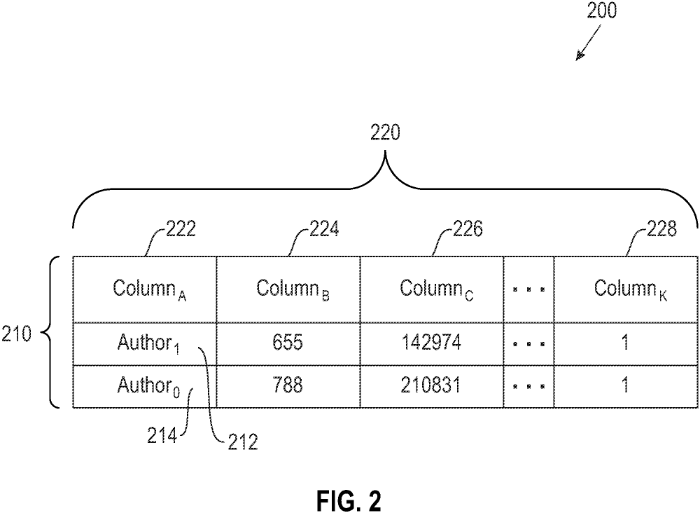

Referring to FIG. 2, a block diagram (200) is provided to illustrate transformation of graph data into a format that can be processed by a neural network. Node feature information articulates data associated with nodes represented in the graph. The node feature information is a representation of the individual objects of the graph, and their associated context. In an exemplary embodiment, node feature information is organized into a multi-dimensional representation. As shown herein by way of example, the representation is in the form of a matrix having multiple dimensions, shown herein as a first dimension (210) and a second dimension (220). Although only two dimensions are represented, the quantity should not be considered limiting, and in an embodiment, the dimensions may be limited to a single dimension or may include more than two dimensions. In the example shown herein, the first dimension (210) is represented as rows and the second dimension (220) is represented as columns. Two entries are shown herein in the first dimension (210) by way of example, with each entry corresponding to a node from the example graph shown in FIG. 1. A first entry (212) corresponds to node_{A} (110) and a second entry (214) corresponds to node_{B} (120). The second dimension (220) is shown with multiple columns, shown herein as column_{A} (222), column_{B} (224), column_{C} (226), ... , column_{K} (228). Although only four columns are shown herein, the quantity of columns may be fewer or greater than that shown, and as such the quantity of columns should not be considered limiting. In an exemplary embodiment, the columns in the second dimension (220) represent features or feature data of the corresponding node. Based on the example of FIG. 1 with the nodes representing individual authors, the columns of the second dimension may represent feature data associated with each author. For example, column_{A} (222) is shown representing the name of the author, column_{B} (224) is shown representing the quantity of professional papers authored or co-authored, column_{C} (226) is shown representing the quantity of citations associated with the author, and column_{K} (228) is shown representing a research interest of the subject author. Accordingly, as shown herein by way of example, the node feature information is represented in a multi-dimensional format.

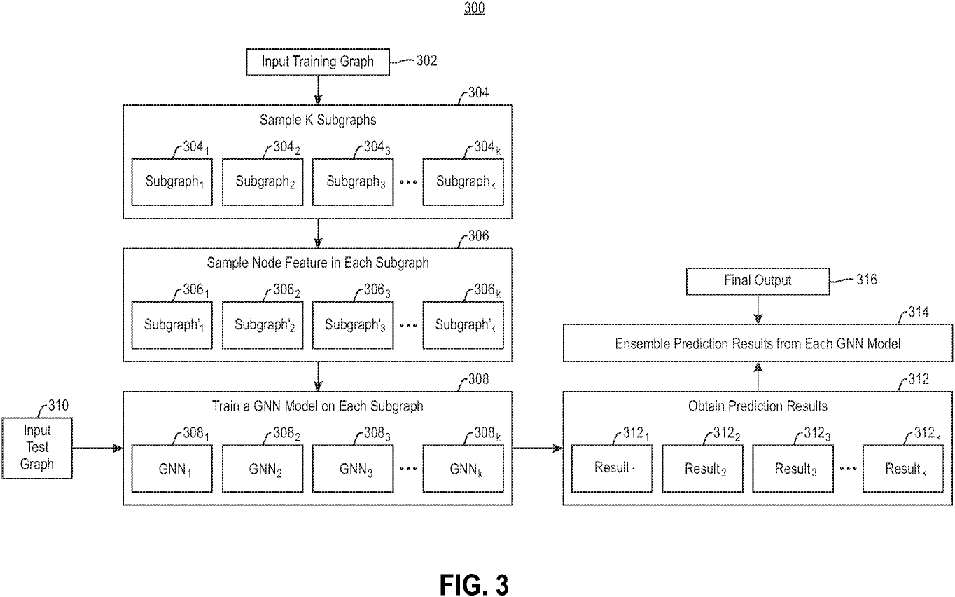

The GNN learns from both the objects and the edges represented in the graph data. When the information represented in the graph data is provided, the GNN extracts patterns and insights from the graph data. As shown and described herein, both structure information and node feature information as represented in the input data are utilized for GNN training. As shown and described herein, the GNN training is extended to ensemble learning. Referring to FIG. 3, a flow diagram (300) is provided to illustrate GNN ensemble training and testing. Training data is known in the art as data used to train an algorithm of a machine learning (ML) model to predict an outcome. In an exemplary embodiment, the training data used to teach a ML model is large, with the data either label for supervised ML models or not labeled for unsupervised ML models. The training data is known in the art as an initial set of data for training the ML model, and is also referred to herein as a training set, a training dataset, or a learning set. In an exemplary embodiment, the training data is complemented by one or more subsequent sets of data referred to herein as validation or testing sets to measure performance of the algorithm or trained ML model, and in an embodiment the measurement includes accuracy or efficiency. As shown herein, a training data set is utilized or received as input (302). In an exemplary embodiment, the training data set is represented in a graph form with nodes representing objects, and edge between nodes representing relationships between objects. From the received training data set, a plurality of subsets of training data are sampled (304). In an exemplary embodiment, the sampling of the training data set at step (304) is random. As shown herein by way of example, the sampling of training data in graph form is shown as subgraphs, e.g. k subgraphs, with each subgraph representing a subset of the nodes and edges of the training data, e.g. 30% of the nodes and edges. As shown herein by way of example, the selected or identified subgraphs from the training data set are shown as subgraph₁ (304₁), subgraph₂ (304₂), subgraphs (304₃), ... , subgraphₖ (304ₖ). In an embodiment, the value of k is configurable, and as such, the quantity of subgraphs shown herein should not be considered limiting. Accordingly, the training data set is separated into multiple subsets, which in an embodiment are represented as subgraphs.

Each subgraph created from the sampling of the training data set at step (304), also referred to herein as training subgraphs, represents a subset of training objects and associated edges. For each of the training subgraphs, feature information from the objects represented in the subgraph nodes, also referred to herein as feature space, is sampled (306). The sampling at step (306) encompasses a subset of the feature space, also referred to herein as a subset of node features, e.g. 10% of the feature space. In an exemplary embodiment, the sampling at step (306) is random, and more specifically, the elements that encompass the subset of the feature space is randomly sampled. In an embodiment, the feature space for each subgraph may be different or may overlap. As shown herein by way of example, the randomly sampled feature space is shown herein as subgraph′₁ (306₁), subgraph′₂ (306₂), subgraph′₃ (306₃), ... , subgraph′ₖ (306ₖ). Using the randomly sampled feature space, multiple GNN models, e.g. k GNN models, are trained on the training data represented in each corresponding subgraph (308). GNNs are a category or type of ML algorithm that can extract information from graphs to create output in the form of predictions, As shown herein by way of example, the GNN models being trained at step (308) are shown as GNN₁ (308₁), GNN₂ (308₂), GNN₃ (308₃), ... , GNNₖ (308ₖ), with GNN₁ (308₁) subject to training on subgraph′₁ (306₁), GNN₂ (308₂) subject to training on subgraph′₂ (306₂), GNN₃ (308₃) subject to training on subgraph′₃ (306₃), ... , GNNₖ (308ₖ) subject to training on subgraph′ₖ (306ₖ),. Accordingly, as shown herein multiple GNNs models are subject to training, with each GNN models trained on a sampled set of feature space from a sampling of the training data set.

A testing data set is received as input (310), and is leveraged to measure performance of the GNN models trained at step (308). In an exemplary embodiment, similar to the training data set received at step (302), the testing data set received at step (310) is represented in a graph form with nodes representing objects, and edge between nodes representing relationships between objects. In an embodiment, the testing set is directed at data that was not present in the training data employed to at step (302), i.e., the training and testing data are separate, a setting known in the art as “inductive learning”. The testing set received at step (310) is applied to each trained GNN (312). In an embodiment, the testing data applied at step (312) is the same testing data for each GNN trained at step (308). In an embodiment, each GNN trained at step (308) is an inductive GNN. Output data, which in an embodiment is in the form of a prediction result, is created from each trained GNN model in receipt of the testing data (312). As shown herein, predictions results are shown as result₁ (312₁), result₂ (312₂), results (312₃), ... , resultₖ (312ₖ), with GNN₁ (308₁) producing result₁ (312₁), GNN₂ (308₂) producing result₂ (312₂), GNN₃ (308₃) producing results (312₃), ... , GNNₖ (308ₖ) producing resultₖ (312ₖ). Examples of prediction results include, but are not limited to, a link prediction between two nodes and classification of a node. Accordingly, each trained GNN generates a prediction as output associated from application of the testing data set.

Ensemble learning refers to a group of ensembles or learners, or models, which work collectively to achieve a final prediction. More specifically, ensemble learning is the use of algorithms or tools in machine learning (ML) to form a collaborative whole, where multiple methods are more effective than a single learning method. A single model, also known as a base learner or weak learner, may not perform well individually due to high variance or high bias. When weak learning models, e.g. ML models, are aggregated, they can form a stronger output, e.g. prediction, as their combination reduces bias or variance, yielding better model performance. As shown herein, the prediction results, e.g. result₁ (312₁), result₂ (312₂), results (312₃), ... , resultₖ (312ₖ), from each corresponding trained GNN, e.g. GNN₁ (308₁), GNN₂ (308₂), GNN₃ (308₃), ... , GNNₖ (308ₖ), are subject to an ensemble ML algorithm to combine the predicted values from the trained GNNs to compute the ensemble score value (314). In an embodiment, the ensemble ML algorithm uses voting to select a category or label. Different voting schemes are known in the art and may be employed at step (314), including majority voting of the contributing GNN, weighted voting of the contributing GNN, and stacking. Majority voting is an algorithm in which a predicted target label of the ensemble is the mode of a distribution of individually predicted labels. The weighted voting algorithm applies a confidence or propensity value for each prediction. The weights are then summed, and the value with the highest total is selected. The stacking is an algorithm that learns how to best combine the predictions from the contributing GNNs. The results of the ensemble learning generate output (316), which in an embodiment may be in the form of a predicted link or a node classification in the testing data set. Accordingly, as shown herein, the structural information of the graph is subject to exploration, and multiple subgraphs of the original graph are used for learning and prediction.

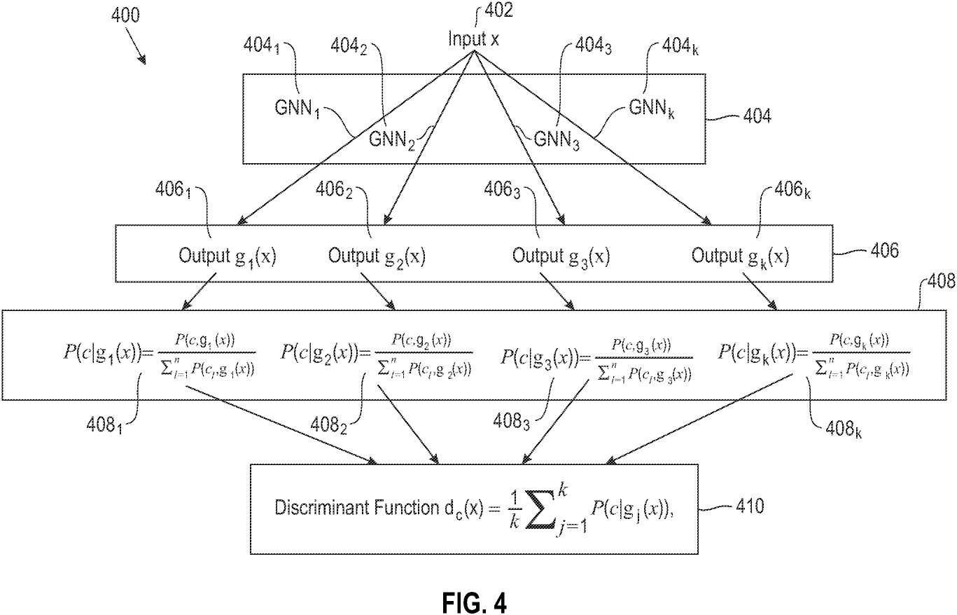

Referring to FIG. 4, a flow diagram (400) is provided to illustrate application of a discriminant function with respect to ensemble learning. As show, similar to step (310) a testing data set, shown herein as input x, is received as input (402). In an exemplary embodiment, the testing data set is in a graph format with nodes and edges. The testing set is applied to each trained GNN model (404), shown herein as GNN₁ (404₁), GNN₂ (404₂), GNN₃ (404₃), ... , GNNₖ (404ₖ). In an embodiment, the trained GNN models are similar or equivalent to trained GNN models GNN₁ (308₁), GNN₂ (308₂), GNN₃ (308₃), ... , GNNₖ (308ₖ). Each trained GNN model generates output or prediction data (406). More specifically, GNN₁ (404₁) generates output g₁(x) (406₁), GNN₂ (404₂) generates output g₂(x) (406₂), GNN₃ (404₃) generates output g₃(x) (406₃), ... , GNNₖ (404ₖ) generates output gₖ(x) (406ₖ). Accordingly, gⱼ(x) is the output from GNNⱼ. The posterior probability that the input, e.g. input x, belongs to a class c (c = 1, 2, ..., n) is denoted as P(c|gⱼ(x)), where gⱼ(x) is the output from GNNⱼ. As shown herein, the posterior probability is assessed for the output generated from testing data applied to each trained GNN model (408), and shown herein as P(c|g₁(x)) (408₁), P(c|g₂(x)) (408₂), P(c|g₃(x)) (408₃), and P(c|gₖ(x)) (408ₖ), where

$$P \left(c \left|{g}_{j} \left(x\right)\right)\right) = \frac{P \left(c , {g}_{j} \left(x\right)\right)}{{\sum }_{l = 1}^{n} P \left({c}_{l} , {g}_{j} \left(x\right)\right)} ,$$

which is the probability of GNNⱼ outputting class c over the summation of the probabilities of GNNⱼ outputting each of the classes. Since the summation of the probabilities of GNNⱼ outputting each of the classes is 1.0, P (c|gⱼ(x)) = P (c,gⱼ(x)), Following the posterior probability assessment, an averaging over the posterior probabilities in these neighborhoods (decision regions) takes place (410), i.e., a discriminant function

$${\text{d}}_{\text{c}} \left(\text{x}\right) = \frac{1}{k} {\sum }_{j = 1}^{k} P \left(c \left|{g}_{j}\right) \left(x\right)\right) .$$

The decision rule is to assign x to class c for which d_{c}(x) is the maximum. As shown, the averaging over the posterior probabilities is conditioned on each of the independently trained GNN models. Geometrically, each trained GNN model defines a neighborhood around the decision space assigned to that node in the chosen sub feature space and subgraph. By averaging over the posterior probabilities in these neighborhoods, also referred to herein as decision regions, the discriminant function approximates the posterior probability for a given input in the original decision making space.

All machine learning systems are trained using training data sets that are assumed to be representative and valid for the subject matter in question. However, malicious actors can impact how the artificial intelligence system functions by modifying the training data with inaccurate or false data. This threat is exacerbated when the machine learning pipeline that includes data collection, curation, labeling, and training is not controlled completely by the model owner. Inaccurate or false data present threats that are particularly relevant when training data is obtained from untrusted sources, such as crowdsourced data or customer behavior data. Additionally, the risk increases when the model requires frequent retraining or customization. The ability to detect when models have been subject to inaccurate data, false data, or data that has been tampered with, or mitigation of such attacks, is vital when they are trained by untrusted third-parties. Injecting bad data is referred to as tampering of data and is referred to in the art as an adversarial attack, and the data is referred to as adversarial data that has intentionally been designed to cause the model to make a mistake, also referred to herein as an adversarial attack on the associated ML model. With respect to data in a graphical format, adversarial attacks are known to perturb the graph structure and/or node features, either or both which may result in degradation of model performance.

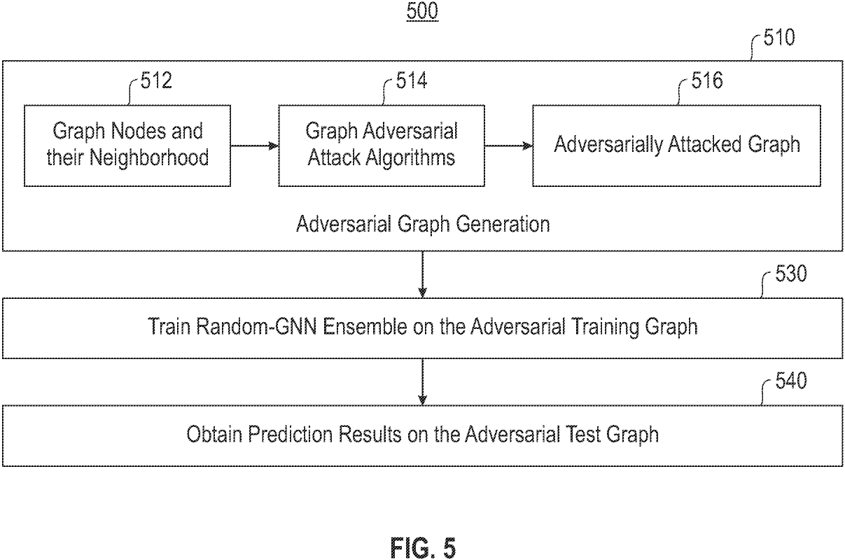

It is understood in that an adversarial attack is directed at entity injecting bad data or modifying data to deceive a ML model to make an incorrect prediction or output. In an exemplary embodiment, the tampered data is referred to as noise, and is injected during training a ML model, or in an embodiment is injected during testing of the trained ML model. In an embodiment, the noise in the corresponding data set is in the form of data manipulation, such as adding one or more edges between nodes, removing one or more existing edges in the graph, modification of a node classification, etc. Noise injection in an embodiment may be minimal, thereby making the noise less apparent and challenging to identify prior to application to the ML model. Referring to FIG. 5, a flow chart (500) is provided to illustrate application of an adversarial attack to the trained GNN ensemble shown and described in FIG. 3. As shown herein, the GNNs are trained under an adversarial umbrella (510). More specifically, training data is received (512) and subject to an adversarial attack (514). In an embodiment, the adversarial attack may be in the form of exposing the training data set to an attack algorithm that effectively injects noise into the training data set. As shown in FIG. 3, the training data set, whether or not subject to an adversarial attack is leveraged to trained ML models in the form of GNNs. The attacked training data set at step (514) is leveraged to train the GNNs (516), thereby generating multiple GNNs training with a training data set injected with noise. Accordingly, the generated and trained GNNs shown herein have been subject to an adversarial attack during the training state.

An adversarial graph is generated by modifying the training dataset with noise (510), modifying a testing dataset with noise, or modifying both the training and testing datasets with noise. As shown herein in this example, the training data set is the subject of the adversarial attack generating GNNs trained with noise present in the training data set. The trained GNNs from step (516) are the subject to a random GNN ensemble training and testing (530), as shown and described in FIG. 3. Prediction results on the adversarial test graph are obtained as output (540). The prediction results at step (540) are a product of ensemble aggregation shown and described in FIGS. 3 and 4, which inherently mitigates the effect of the adversarial attack through the random elements of the GNN model training, including the random sampling of subgraphs and random sampling of feature(s), e.g. nodes, in each subgraph. More specifically, a selection of the GNNs that are the subject of the random sampling of the GNNs during the ensemble training and testing at step (530) have been trained with noise, while some of the GNNs were trained with untampered data. A by-product or result of the ensemble aggregation mitigates, or in an embodiment selectively removes, the effect of the adversarial attack.

It is understood in the art that an adversarial attack wants the modification to be subtle so that an innocent user would not find out or otherwise be aware of the attack. For example, the adversarial attack may be in the form of adding or removing 3% of the edges in the dataset, while the majority of the node and edges remains unchanged. As shown in FIG. 3, the structural information of the graph is explored and multiple subgraphs of the original graph are used for learning and prediction. One direct benefit of this is that most subgraphs containing the victim node, e.g. the node targeted to create the adversarial characteristic(s), will be less likely to be impacted by the malicious modification edge and still presents the victim node correctly. It is the randomness together with the ensemble training that mitigates the effectiveness of the adversarial attack(s). The ensemble learning spreads out the results of the random sampling across a plurality of subgraphs, so that the probability and possibility of the adversarial attack being present is spread across each of the randomly sampled subgraphs. Each model in the ensemble makes a prediction, and based on the plurality of the models that voting algorithm is applied to a plurality of predictions. In an embodiment, an increased or greater quantity of models in the ensemble mitigates the effectiveness of the adversarial attack. Accordingly, the GNN ensemble combines multiple models to both improve learning performance and mitigate adversarial robustness.

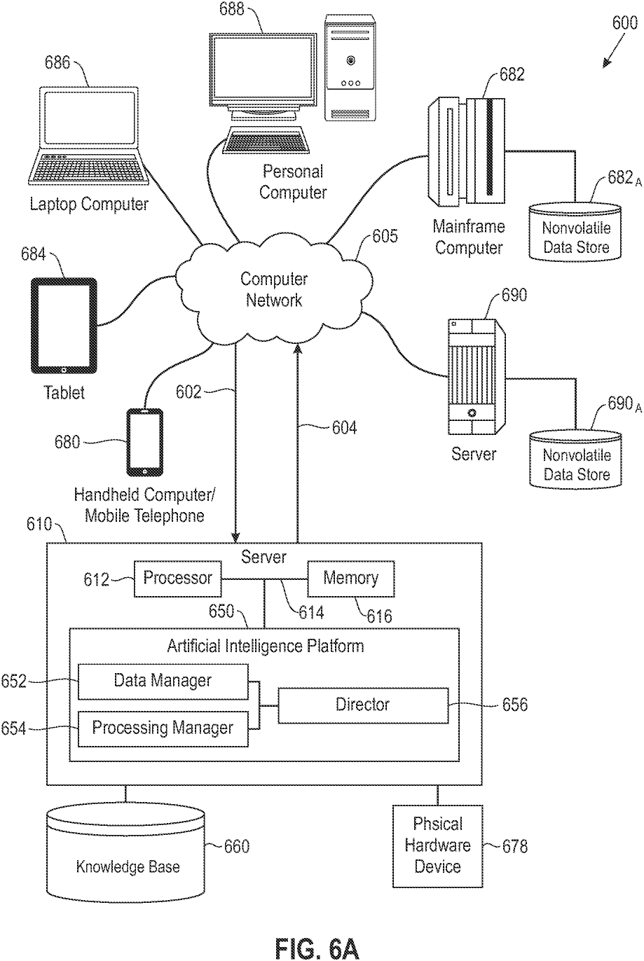

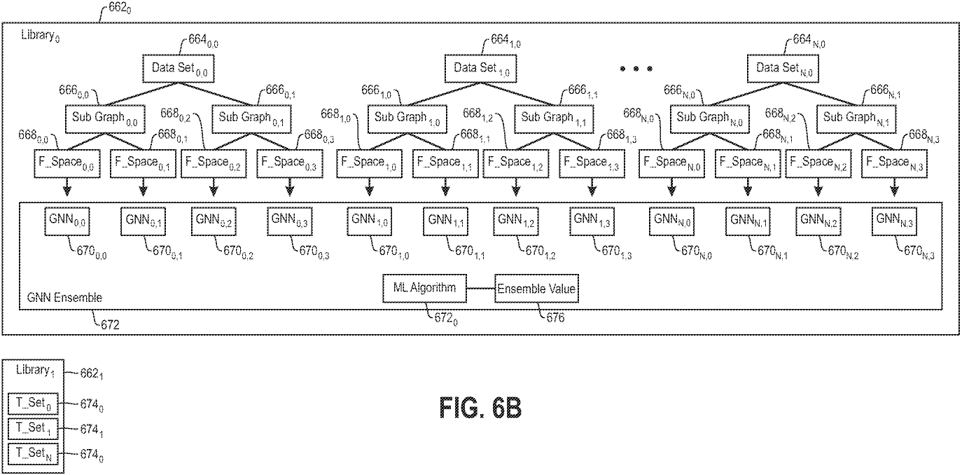

Referring to FIGS. 6A and 6B, a block diagram (600) is provided to illustrate a computer system with tools to support and enable ensemble learning to improve learning performance and adversarial robustness for a GNN. The tools represent a framework to support and enable the ensemble learning. The system and associated tools, as described herein, support ensemble training and testing to mitigate the effects of noise injection into one or more of the training data set and the testing data set. As shown, a server (610) is provided in communication with a plurality of computing devices (680), (682), (684), (686), (688), and (690) across a network connection (605). The server (610) is configured with a processing unit (612), also referred to herein as a processor, operatively coupled to memory (616) across a bus (614). An artificial intelligence (AI) platform (650) is shown local to the server (610), and operatively coupled to the processing unit (612) and memory (616). As shown, the AI platform (650) contains tools in the form of a data manager (652), a processing manager (654), and a director (656). Together, the tools provide functional support for GNN training and testing over the network (605) from one or more computing devices (680), (682), (684), (686), (688), and (690). The computing devices (680), (682), (684), (686), (688), and (690) communicate with each other and with other devices or components via one or more wires and/or wireless data communication links, where each communication link may comprise one or more of wires, routers, switches, transmitters, receivers, or the like. In this networked arrangement, the server (610) and the network connection (605) enable GNN training and testing, and more specifically application of ensemble learning to the GNN training and testing. The ensemble learning mitigates, and in an embodiment effectively negates, the effect of an adversarial attack associated with noise injection into the training data set, the testing data set, or a combination of the training and testing data sets. Other embodiments of the server (610) may be used with components, systems, sub-systems, and/or devices other than those that are depicted herein.

The tools, including the AI platform (650), or in one embodiment, the tools embedded therein including the data manager (652), the processing manager (654), and the director (656), may be configured to receive input from various sources, including but not limited to input from the network (605), and an operatively coupled knowledge base (660). As shown herein, the knowledge base (660) includes a first library, library₀ (662₀), of training data sets, shown herein as data set_{0,0} (664_{0,0}), data set_{1,0} (664_{1,0}), ... , data set_{N,0} (664_{N,0}). In an exemplary embodiment, and as described in FIG. 3, each of the training data sets is represented in a graph format. In an embodiment, the training data sets may individually or collectively be communicated to the AI platform (650) across the network (605). The quantity of training data sets in the first library, library₀ (662₀), is for illustrative purposes and should not be considered limiting. As shown herein, the data manager (652) is configured to process the training data to support building and executing a GNN ensemble. More specifically, the data manager is configured to randomly sample two or more subgraphs from the graph format of the training set. As shown herein by way of example, data set_{0,0} (664_{0,0}) is shown with subgraph_{0,0} (666_{0,0}) and sugraph_{0,1} (666_{0,1}), data set_{1,0} (664_{1,0}) is shown with subgraph_{1,0} (666_{1,0}) and subgraph_{1,1} (666_{1,1}), ... , and data set_{N,0} (664_{N,0}) is shown with subgraph_{N,0} (666_{N,0}) and sugraph_{N,1} (666_{N,1}). Although each data set is shown herein with only two sampled subgraphs, this quantity of subgraphs should not be considered limiting, and in an exemplary embodiment exceeds the quantity shown herein.

The data manager (632) is further configured to randomly sample feature space from each of the randomly sampled subgraphs of training data. As shown herein by way of example, subgraph_{0,0} (666_{0,0}) is shown with feature space, hereinafter referred to as f_space, and shown as herein by way of example as f_space_{0,0} (668_{0,0}), and f_space_{0,1} (668_{0,1}). Similarly, subgraph_{0,1} (666_{0,1}) is shown with f_space_{0,2} (668_{0,2}) and f_space_{0,3} (668_{0,3}), ... , and data set_{N,1} (664_{N,1}) is shown with f_space_{N,2} (668_{N,2}) and f_space_{N,3} (668_{N,3}). Although only two sets of feature space is shown sampled from each subgraph, this quantity is for illustrative purposes, and should not be considered limiting. Accordingly, the processing manager (354) interfaces with the data manage (352) to sample subgraphs from the graph format of the training set and to sample feature space from each of the sample subgraphs.

In addition to sampling the training data, the processing manager (354) is configured to train two or more GNNs in support of ensemble learning. The data from the feature space is configured to train a GNN. As shown herein, f_space_{0,0} (668_{0,0}) is employed to train GNN_{0,0} (670_{0,0}), f_space_{0,1} (668_{0,1}) is employed to train GNN_{0,1} (670_{0,1}), f_space_{0,2} (668_{0,2}) is employed to train GNN_{0,2} (670_{0,2}), f_space_{0,3} (668_{0,3}) is employed to train GNN_{0,3} (670_{0,3}), ... , f_space_{N,3} (668_{N,3}) is employed to train GNN_{N,3} (670_{N,3}). The quantity of trained GNNs is for illustrative purposes and should not be considered limiting. In an exemplary embodiment, each trained GNN is stored in the library (662) and associated with its corresponding feature space. Similarly, in an exemplary embodiment, the knowledge base (660) may include one or more additional libraries each having training data sets accessible by the processing manager (354) for sampling of subgraphs and feature space, and training one or more GNNs from the sampled feature space. As such, the quantity of libraries shown and described herein should not be considered limiting. The processing manager (354) is further configured to build a GNN ensemble with the trained GNNs. By way of example, the GNN ensemble (672) represents the trained GNNs from the sampled feature space, with the GNN ensemble (672) encompassing GNN_{0,0} (670_{0,0}), GNN_{0,1} (670_{0,1}), GNN_{0,2} (670_{0,2}), GNN_{0,3} (670_{0,3}), GNN_{1,0} (670_{1,0}), GNN_{1,1} (670_{1,1}), GNN_{1,2} (670_{1,2}), GNN_{1,3} (670_{1,3}), GNN_{N,0} (670_{N,0}), GNN_{N,1} (670_{N,1}), GNN_{N,2} (670_{N,2}), and GNN_{N,3} (670_{N,3}). Accordingly, the GNN ensemble (672) is populated with a plurality of GNNs each trained from a sampling of subgraphs from the training data set, and more specifically from a sampling of feature space within the sampled subgraphs.

The various computing devices (680), (682), (684), (686), (688), and (690) in communication with the network (605) demonstrate access points for the AI platform (650) and the corresponding tools, including the data manager (652), the processing manager (654), and the director (656). Some of the computing devices may include devices for use by the AI platform (650), and in one embodiment the tools (652), (654), and (656), to support and enable GNN ensemble learning, and dynamically generating a control signal to a physical hardware device or a process controlled by software, or a combination of the hardware device and the software, with the control signal associated with the output constructed from the GNN ensemble (672). In an exemplary embodiment, the control signal is configured to selectively control a physical state of the operatively coupled device or the software. As shown herein, the director (656) is operatively coupled to the processing manager (654), with the director (656) configured to leverage the GNN ensemble (672). As shown and described in FIG. 3, the GNN ensemble is configured to receive a testing data set as input to each trained GNN. In the example shown herein, the knowledge base (660) is configured with a second library, library₁ (662₁), populated with testing data sets, shown herein as t_set₀ (674₀), t_set₁ (674₁), ... , t_set_{N} (674_{N}). In an embodiment, each training data set has a corresponding or associated testing data set. The testing data sets are shown herein stored in the second library, library₁ (662₁), although in an embodiment, the testing data sets may be stored in the first library, library₀ (662₀). Similarly, in an embodiment, the testing data sets may be received from one or more of the computing devices (680), (682), (684), (686), (688), and (690) in communication with the network (605).

As each GNN in the GNN ensemble (672) processes the corresponding testing dataset, output data in the form of a prediction is generated. In an embodiment, the director (656) is configured to assess a posterior probability for the output prediction from each GNN in the ensemble (672), and more specifically, with the director (656) configured to average the posterior probability from each GNN output. The GNN ensemble (672) is further shown with an ensemble ML algorithm (672₀) which is configured to combine the predicted values from the trained GNNs to compute the ensemble value (676). In an embodiment, the ensemble ML algorithm (672₀) uses voting to select a category or label. Different voting schemes are known in the art and described in FIG. 3, with the voting scheme configured to be leveraged by the director (656) for selecting a value from the outputs of the GNNs as the ensemble value (676). In an exemplary embodiment, the ensemble value (676) may be in the form of a predicted link or a node classification in a corresponding data set. As described above, the training data set or the testing data set may have been exposed to or the subject of an adversarial attack.

By way of example, a physical hardware device (678) is shown operatively coupled to the server (610). In an exemplary embodiment, a control signal in alignment with the ensemble value (676) is issued and leveraged to selectively control the operatively coupled physical hardware device (678), with the control signal selectively modifying a physical functional aspect of the device (678). In an embodiment, the device (678) may be a first physical device operatively coupled to an internal component, or in an embodiment a second physical device, and the issued first signal may modify an operating state of the internal component or the second device. For example, the first device (678) may be a product dispenser, and the control signal may modify or control a product dispensing rate to accommodate the rate at which the second device receives the dispensed product. In an embodiment, the director (656) computes a control action based on ensemble value (678), and constructs or configures the control signal that aligns or is commensurate with the computed or selected ensemble value (676). In an exemplary embodiment, the control action may be applied as a feedback signal to directly control an event injection to maximize a likelihood of realizing an event or operating state of the device (378).

The network (605) may include local network connections and remote connections in various embodiments, such that the AI platform (650) and the embedded tools (652), (654), and (656) may operate in environments of any size, including local and global, e.g. the Internet, distributed cloud computing environment, etc. Accordingly, the server (610) and the AI platform (650) serve as a front-end system, with the knowledge base (660) serving as the back-end system.

Although shown as being embodied in or integrated with the server (610), the AI platform (650) may be implemented in a separate computing system (e.g., 690) that is connected across the network (605) to the server (610). Similarly, although shown local to the server (610), the tools (652), (654), and (656) may be collectively or individually distributed across the network (605). Wherever embodied, the data manager (652), the processing manager (654), and the director (656) are utilized to support and enable GNN ensemble learning, which in an embodiment, mitigates the effect of an adversarial attack to the training data set or the testing data set for a GNN.

Types of information handling systems that can utilize server (610) range from small handheld devices, such as a handheld computer/mobile telephone (680) to large mainframe systems, such as a mainframe computer (682). Examples of a handheld computer (680) include personal digital assistants (PDAs), personal entertainment devices, such as MP4 players, portable televisions, and compact disc players. Other examples of information handling systems include a pen or tablet computer (684), a laptop or notebook computer (686), a personal computer system (688) and a server (690). As shown, the various information handling systems can be networked together using computer network (605). Types of computer network (605) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (690) utilizes nonvolatile data store (690_{A}), and mainframe computer (682) utilizes nonvolatile data store (682_{A}). The nonvolatile data store (682_{A}) can be a component that is external to the various information handling systems or can be internal to one of the information handling systems.

Information handling systems may take many forms, some of which are shown in FIG. 3. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

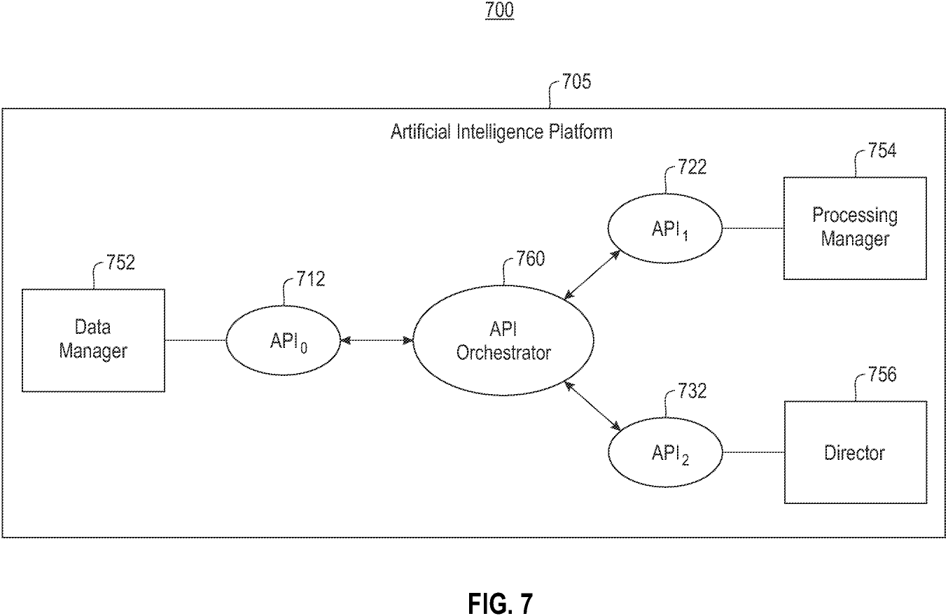

An Application Program Interface (API) is understood in the art as a software intermediary between two or more applications. With respect to the embodiments shown and described in FIGS. 6A and 6B, one or more APIs may be utilized to support one or more of the AI platform tools, including the data manager (652), the processing manager (654), and the director (656), and their associated functionality. Referring to FIG. 7, a block diagram (700) is provided illustrating the AI platform tools and their associated APIs. As shown, a plurality of tools are embedded within the AI platform (705), with the tools including the data manager (752) associated with API₀ (712), the processing manager (754) associated with API₁ (722), and the director (756) associated with API₂ (732). Each of the APIs may be implemented in one or more languages and interface specifications.

API₀ (712) provides support for processing a training data set in preparation for GNN ensemble training, which includes presentation of the training data set in a graph with nodes representing objects and edges representing an affinity between two objects. API₁ (722) provides support for processing the training data set. The processing includes sampling subgraphs from the training data set and sampling feature space from the sampled subgraphs. In an exemplary embodiment, the sampling supported by API₁ (722) is conducted randomly or invokes a random selection algorithm. API₁ (722) also provides support for training GNNs, with separate GNNs trained from each sampled feature space. In an embodiment, one training API₁ (722) provides support for building the GNN ensemble with the trained GNNs. API₂ (732) provides support for application of a testing data set to the GNN ensemble, which includes constructing output associated with execution of the GNN ensemble. In an embodiment, the constructed output is configured to interface with the functionality of an operatively coupled device.

As shown, each of the APIs (712), (722), and (732) are operatively coupled to an API orchestrator (760), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

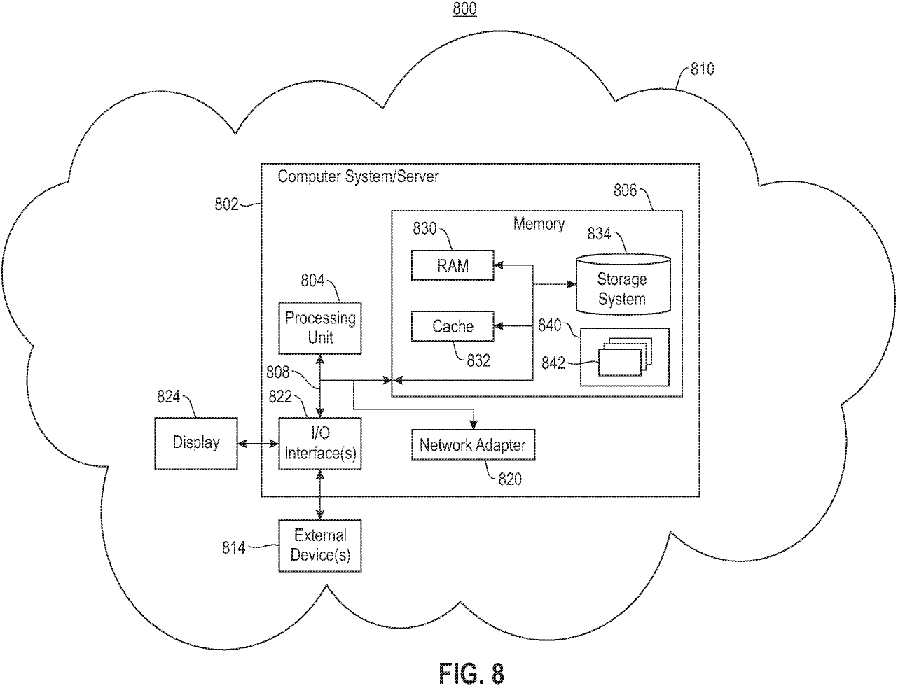

As shown and described above in FIGS. 6A and 6B, aspects of the tools (652), (654), and (656) and their associated functionality may be embodied in a computer system/server in a single location, or in an embodiment, may be configured in a cloud based system sharing computing resources. With references to FIG. 8, a block diagram (800) is provided illustrating an example of a computer system/server (802), hereinafter referred to as a host (802) in communication with a cloud based support system, to implement the system and processes described above with respect to FIGS. 1-7. Host (802) is operational with numerous other general purpose or special purpose computing system environments or configurations. Examples of well-known computing systems, environments, and/or configurations that may be suitable for use with host (802) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (802) may be described in the general context of computer system-executable instructions, such as program modules, being executed by a computer system. Generally, program modules may include routines, programs, objects, components, logic, data structures, and so on that perform particular tasks or implement particular abstract data types. Host (802) may be practiced in distributed cloud computing environments (810) where tasks are performed by remote processing devices that are linked through a communications network. In a distributed cloud computing environment, program modules may be located in both local and remote computer system storage media including memory storage devices.

As shown in FIG. 8, host (802) is shown in the form of a general-purpose computing device. The components of host (802) may include, but are not limited to, one or more processors or processing units (804), a system memory (806), and a bus (808) that couples various system components including system memory (806) to processor (804). Bus (808) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (802) typically includes a variety of computer system readable media. Such media may be any available media that is accessible by host (802) and it includes both volatile and non-volatile media, removable and non-removable media.

Memory (806) can include computer system readable media in the form of volatile memory, such as random access memory (RAM) (830) and/or cache memory (832). By way of example only, storage system (834) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (808) by one or more data media interfaces.

Program/utility (840), having a set (at least one) of program modules (842), may be stored in memory (806) by way of example, and not limitation, as well as an operating system, one or more application programs, other program modules, and program data. Each of the operating systems, one or more application programs, other program modules, and program data or some combination thereof, may include an implementation of a networking environment. Program modules (842) generally carry out the functions and/or methodologies of GNN ensemble learning. For example, the set of program modules (842) may include the modules configured as the tools (652), (654), and (656) described in FIGS. 6A and 6B.

Host (802) may also communicate with one or more external devices (814), such as a keyboard, a pointing device, a sensory input device, a sensory output device, etc.; a display (824); one or more devices that enable a user to interact with host (802); and/or any devices (e.g., network card, modem, etc.) that enable host (802) to communicate with one or more other computing devices. Such communication can occur via Input/Output (I/O) interface(s) (822). Still yet, host (802) can communicate with one or more networks such as a local area network (LAN), a general wide area network (WAN), and/or a public network (e.g., the Internet) via network adapter (820). As depicted, network adapter (820) communicates with the other components of host (802) via bus (808). In one embodiment, a plurality of nodes of a distributed file system (not shown) is in communication with the host (802) via the I/O interface (822) or via the network adapter (820). It should be understood that although not shown, other hardware and/or software components could be used in conjunction with host (802). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (806), including RAM (830), cache (832), and storage system (834), such as a removable storage drive and a hard disk installed in a hard disk drive.

Computer programs (also called computer control logic) are stored in memory (806). Computer programs may also be received via a communication interface, such as network adapter (820). Such computer programs, when run, enable the computer system to perform the features of the present embodiments as discussed herein. In particular, the computer programs, when run, enable the processing unit (804) to perform the features of the computer system. Accordingly, such computer programs represent controllers of the computer system.

In one embodiment, host (802) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

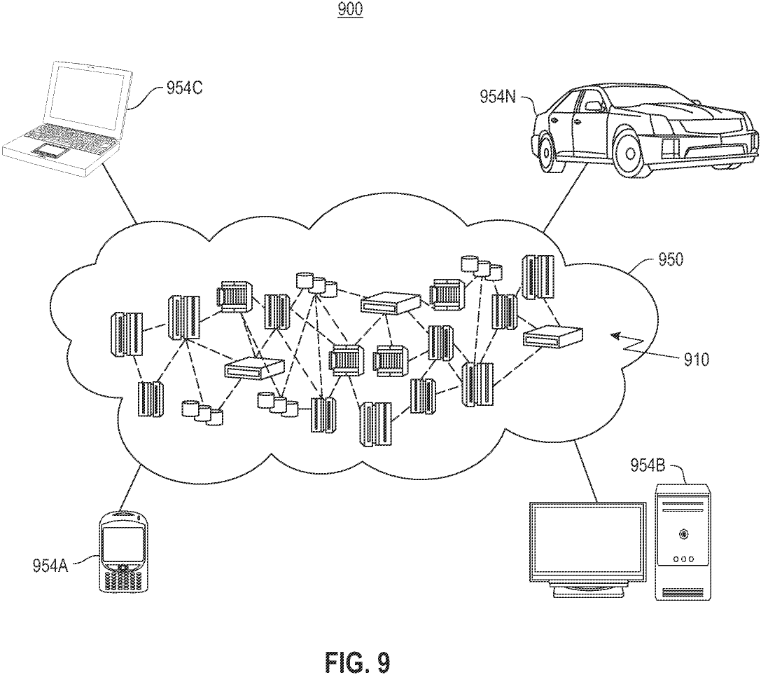

Referring now to FIG. 9, an illustrative cloud computing network (900). As shown, cloud computing network (900) includes a cloud computing environment (950) having one or more cloud computing nodes (910) with which local computing devices used by cloud consumers may communicate. Examples of these local computing devices include, but are not limited to, personal digital assistant (PDA) or cellular telephone (954A), desktop computer (954B), laptop computer (954C), and/or automobile computer system (954N). Individual nodes within nodes (910) may further communicate with one another. They may be grouped (not shown) physically or virtually, in one or more networks, such as Private, Community, Public, or Hybrid clouds as described hereinabove, or a combination thereof. This allows cloud computing environment (900) to offer infrastructure, platforms and/or software as services for which a cloud consumer does not need to maintain resources on a local computing device. It is understood that the types of computing devices (954A-N) shown in FIG. 9 are intended to be illustrative only and that the cloud computing environment (950) can communicate with any type of computerized device over any type of network and/or network addressable connection (e.g., using a web browser).

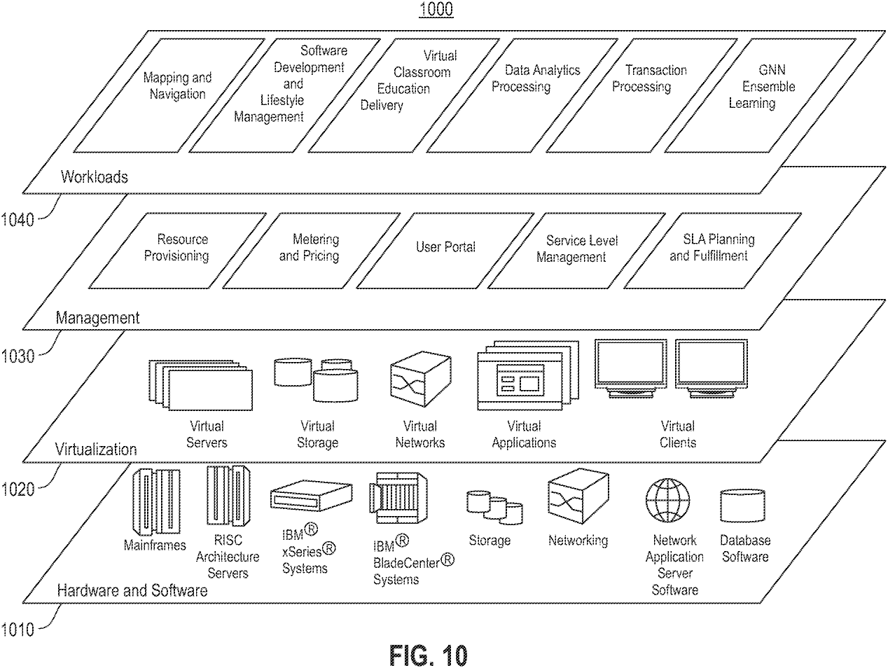

Referring now to FIG. 10, a set of functional abstraction layers (1000) provided by the cloud computing network of FIG. 9 is shown. It should be understood in advance that the components, layers, and functions shown in FIG. 10 are intended to be illustrative only, and the embodiments are not limited thereto. As depicted, the following layers and corresponding functions are provided: hardware and software layer (1010), virtualization layer (1020), management layer (1030), and workload layer (1040). The hardware and software layer (1010) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (1020) provides an abstraction layer from which the following examples of virtual entities may be provided: virtual servers; virtual storage; virtual networks, including virtual private networks; virtual applications and operating systems; and virtual clients.

In one example, management layer (1030) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (1040) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and GNN ensemble learning.

The system and flow charts shown herein may also be in the form of a computer program device for entity linking in a logical neural network. The device has program code embodied therewith. The program code is executable by a processing unit to support the described functionality.

While particular embodiments have been shown and described, it will be obvious to those skilled in the art that, based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles.

The present embodiment(s) may be a system, a method, and/or a computer program product. In addition, selected aspects of the present embodiment(s) may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiment(s) may take the form of computer program product embodied in a computer readable storage medium (or media) having computer readable program instructions thereon for causing a processor to carry out aspects of the present embodiment(s). Thus embodied, the disclosed system, a method, and/or a computer program product are operative to improve the functionality and operation of dynamical orchestration of a pre-requisite driven codified infrastructure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server or cluster of servers. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiment(s). In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiment(s). In particular, the pipeline processing and execution may be carried out by different computing platforms or across multiple devices. Furthermore, the libraries may be localized, remote, or spread across multiple systems. Accordingly, the scope of protection of the embodiment(s) is limited only by the following claims and their equivalents.

What is claimed is:

1. A computer system comprising:
a processor operatively coupled to memory;
an artificial intelligence (AI) platform, operatively coupled to the processor, comprising:
a data manager configured to process a training data set, including represent the training data set in a graph, the graph including a plurality of nodes and edges, wherein an edge connecting two nodes represents an affinity between the two nodes;
a processing manager, operatively coupled to the data manager, the processing manager configured to:
sample a plurality of subgraphs from the training data set;
sample feature space from the sampled subgraphs;
train two or more graph neural networks (GNNs), each GNN
trained from the sampled feature space; and
build a GNN ensemble with the trained two or more GNNs; and
a director configured to apply a testing data set to the GNN ensemble, the application configured to execute the GNN ensemble and construct output from the executed GNN ensemble, the constructed output configured to selectively interface with functionality of an operatively coupled device.

2. The computer system of claim 1, further comprising the director configured to dynamically configure and issue a control signal, the control signal configuration based on the constructed output, to the operatively coupled device, the device being a physical hardware device, a process controlled by software, or a combination thereof, the control signal configured to selectively control a physical state of the operatively coupled device or the software.

3. The computer system of claim 1, wherein execution of the GNN ensemble includes output prediction values from the trained two or more GNN models, and wherein a combination of the prediction values produces an ensemble value.

4. The computer system of claim 3, wherein the production of the ensemble value further comprises the director configured to leverage a machine learning voting algorithm to select a value as the ensemble value.

5. The computer system of claim 4, wherein the selected value is a predicted link or a node classification.

6. The computer system of claim 3, wherein execution of the GNN ensemble further comprises the director configured to assess a posterior probability for the output prediction value from each GNN in the ensemble and average the posterior probabilities.

7. The computer system of claim 1, wherein the sampling of the plurality of subgraphs and the sampling of the subset of nodes from each of the plurality of subgraphs is random.

8. A computer program product configured to interface with a computer readable storage medium having program code embodied therewith, the program code executable by a processor to:
process a training data set, including represent the training data set in a graph, the graph including a plurality of nodes and edges, wherein an edge connecting two nodes represents an affinity between the two nodes;
sample a plurality of subgraphs from the training data set;
sample feature space from the sampled subgraphs;
train two or more graph neural networks (GNNs), each GNN trained from the sampled feature space; and
build a GNN ensemble with the trained two or more GNNs; and
apply a testing data set to the GNN ensemble, the application configured to execute the GNN ensemble and construct output from the executed GNN ensemble, the constructed output configured to selectively interface with functionality of an operatively coupled device.

9. The computer program product of claim 8, further comprising program code configured to dynamically configure and issue a control signal, the control signal configuration based on the constructed output, to the operatively coupled device, the device being a physical hardware device, a process controlled by software, or a combination thereof, the control signal configured to selectively control a physical state of the operatively coupled device.

10. The computer program product of claim 8, wherein execution of the GNN ensemble includes output prediction values from the trained two or more GNN models, and wherein a combination of the prediction values produces an ensemble value.

11. The computer program product of claim 10, wherein the production of the ensemble value further comprises program code configured to leverage a machine learning voting algorithm to select a value as the ensemble value.

12. The computer program product of claim 11, wherein the selected value is a predicted link or a node classification.

13. The computer program product of claim 10, wherein execution of the GNN ensemble further comprises program code configured to assess a posterior probability for the output prediction value from each GNN in the ensemble and average the posterior probabilities.

14. A computer implemented method comprising:
processing a training data set, including represent the training data set in a graph, the graph including a plurality of nodes and edges, wherein an edge connecting two nodes represents an affinity between the two nodes;
sampling a plurality of subgraphs from the training data set;
sampling feature space from the sampled subgraphs;
training two or more graph neural networks (GNNs), each GNN trained from the sampled feature space; and
building a GNN ensemble with the trained two or more GNNs; and
applying a testing data set to the GNN ensemble, the application configured to execute the GNN ensemble and construct output from the executed GNN ensemble, the constructed output configured to selectively interface with functionality of an operatively coupled device.

15. The computer implemented method of claim 14, further comprising dynamically configuring and issuing a control signal, the control signal configuration based on the constructed output, to an operatively coupled physical hardware device, a process controlled by software, or a combination thereof, the control signal configured to selectively control a physical state of the operatively coupled device, the software, or a combination thereof.

16. The computer implemented method of claim 14, wherein execution of the GNN ensemble includes output prediction values from the trained two or more GNN models, and wherein a combination of the prediction values produces an ensemble value.

17. The computer implemented method of claim 16, wherein the production of the ensemble value further comprises leveraging a machine learning voting algorithm to select a value as the ensemble value.

18. The computer implemented method of claim 17, wherein the selected value is a predicted link or a node classification.

19. The computer implemented method of claim 16, wherein execution of the GNN ensemble further comprises assessing a posterior probability for the output prediction value from each GNN in the ensemble and averaging the posterior probabilities.

20. The computer implemented method of claim 14, wherein the sampling of the plurality of subgraphs and the sampling of the feature space from the sampled subgraphs is random.
